(19) United States
(12) Patent Application Publication
(10) Pub. No.: US 2026/0182668 A1
(43) Pub. Date: Jul. 2, 2026

(54) AEROSOL-GENERATING DEVICE WITH MODULAR HEATER UNIT

(71) Applicant: Philip Morris Products S.A., Neuchatel (CH)

(72) Inventors: Rui Nuno Rodrigues Alves BATISTA, Morges (CH); Sander BROUWER, Comerio (Varese) (IT)

(73) Assignee: Philip Morris Products S.A., Neuchatel (CH)

(21) Appl. No.: 19/131,756

(22) PCT Filed: Dec. 11, 2023
(86) PCT No.: PCT/EP2023/085070

§ 371 Date: May 21, 2025

(30) Foreign Application Priority Data
Dec. 16, 2022 (EP) 22214178.0

(51) Int. Cl. A24F 40/57; A24F 40/10; A24F 40/20; A24F 40/30; A24F 40/465; H05B 1/02

(52) U.S. Cl. CPC A24F 40/57; A24F 40/10; A24F 40/20; A24F 40/30; A24F 40/465; H05B 1/0202

(57) ABSTRACT

An aerosol-generating device is provided, including: a main body including a power supply and a first connection element; and a first heater component including a second connection element, a heating element, and a receiving region configured to receive an aerosol-forming substrate, the first connection element of the main body being configured to be removably connectable with the second connection element of the first heater component such that the first heater component is mounted abutting the main body and such that electrical energy can be supplied from the power supply to the heating element. A kit including the aerosol-generating device and a second heater component is also provided.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. Instead of using a rod-shaped aerosol-generating article, other aerosol-generating devices use a liquid aerosol-forming substrate to be vaporized by a heating element.

It would be desirable to have an aerosol-generating device with improved variability. It would be desirable to have an aerosol-generating device that can be used with solid aerosol-forming substrates and liquid aerosol-forming substrates.

According to first aspect of the invention there is provided an aerosol-generating device. The aerosol-generating device comprises a main body and a first heater unit. The main body comprises a power supply and a first connection element. The first heater unit comprises a second connection element, a heating element and a receiving region configured to receive an aerosol-forming substrate. The first connection element of the main body is configured to be removably connectable with the second connection element of the first heater unit such that the first heater unit is mounted abutting the main body and such that electrical energy can be supplied from the power supply to the heating element.

The invention may provide a modular aerosol-generating device. The main body may be configured to be used with a variety of different heater units. The main body may be configured to adapt the electrical energy supply to the heating element in dependence of the specific heater unit connected to the main body. The main body may be configured to supply a heater unit specific heating profile to the connected heater unit. The term “heating profile” as used herein may refer to a progression of target temperatures as function of time. A heating profile may include the highest and lowest target temperatures and the heating duration at specific target temperatures. A specific heating profile may be achieved by regulating the supply of power from the power supply to the heating element.

The main body may be configured to supply a heater unit specific current to the connected heater unit. The main body may be configured to supply a heater unit specific voltage to the connected heater unit. The main body may be configured to supply a heater unit specific electrical signal to the connected heater unit. The main body may be configured to supply a heater unit specific electrical signal profile to the connected heater unit. The term “electrical signal profile” as used herein may refer to a progression of an electrical signal as a function of time. The electrical signal profile may refer to the progression of electrical energy supplied as function of time (electrical energy profile). The electrical signal profile may refer to the progression of power supplied as function of time (power profile). The electrical signal profile may also refer to a progression of current supplied as a function of time (current profile). The electrical signal profile may also refer to a progression of voltage supplied as a function of time (voltage profile). The electrical signal profile may also include information on whether a direct or alternating current is supplied at a specific time. The electrical signal profile may also include information on whether a direct or alternating voltage is supplied at a specific time.

The invention allows the main body to be used with a variety of different and readily exchangeable heater units. The end user may exchange the heater units. The configuration of the heater unit may be versatile. For example, different embodiments of the heater unit may comprise different types of aerosol-forming substrates (e.g., liquid or solid aerosol-forming substrate) and heating elements (e.g., resistive or inductive heating element, external or internal heating element).

The provision of the inventive device with separate main body and heater unit provides a variety of advantages. The lifetime of the main body (comprising the power supply) is usually significantly longer than the lifetime of an individual heater unit (comprising aerosol-forming substrate (i.e. a consumable)) or a developmental generation of heater unit. Accordingly, by separating the device into a main body, which can adapt to a specific heater unit attached to it and a heater unit, the main body may be used with more than an individual heater unit, with more than one development generation of the heater unit, and even with completely different types and embodiments of heater units.

A variety of different consumables (e.g., liquid aerosol-forming substrate or solid aerosol-forming substrate) and heating mechanisms (e.g., resistance heating or induction heating) are known. Each type of consumable and heating mechanism may provide the consumer with different consumption experience characteristics. By providing a main body which can be used with heater units comprising different types consumables and heating mechanisms, the invention enables a versatile and consumer-controlled consumption experience. The costs for the consumer are reduced as the consumer does not need to buy a complete device, but can simply reuse the main body with different heater units. Furthermore, the consumers may be encouraged to try new versions, types and generations of heater units. In addition, product development of new heater units is made faster and more versatile as only the heater unit (and not the main body) needs to developed. This also leads to an accelerated market launch.

Finally, provision of a reusable main body leads to a lower environmental impact and lower material consumption in production.

The first connection element and the second connection element may be configured to be complementary to each other. The first connection element and the second connection element may be configured to fix the main body and the heater unit to each other. The first connection element and the second connection element may be configured to couple the heater unit to the main body.

The first connection element of the main body may be configured to be compatible with the second connection element of different heater unit embodiments.

The main body may be configured to detect that a fresh aerosol-generating article or aerosol-forming substrate has been inserted into the heater unit.

The heater unit may comprise a housing. The housing may comprise a base. The housing may comprise one or more walls. The walls may extend from the base. The base and the one or more walls may be integrally formed. The base and one or more sidewalls may be distinct elements that are attached or secured to each other. The housing may be a rigid housing. The walls of the heater unit housing may comprise the heating element.

The main body may comprise an interface. The main body may comprise a user interface. The main body may comprise a visual interface. The interface may be configured such that the user may interact with the aerosol-generating device. The interface may comprise a display. The interface may comprise a touchscreen. The interface may comprise buttons, which are configured such that the user may interact with device using the buttons. The interface may provide the user with information on the heater unit connected to the main body. Such information may include the type of heater unit attached, the level of aerosol-forming substrate remaining in the heater unit and the available heating profiles or electrical signal profiles. The interface may be configured such that the user may select a specific heating profile or electrical signal profile. The user may provide input to the main body via the interface.

The main body may be configured to determine if a heater unit connected to it is fresh. The main body may be configured to determine if a heater unit connected to it is unused. The main body may be configured to monitor the consumption of aerosol-forming substrate of the connected heater unit. The main body may be configured to monitor the level of aerosol-forming substrate of the connected heater unit. The main body may be configured to determine if the heater unit has recently been connected to the main body. The main body may be configured to determine the identity of the connected heater unit. The main body may be configured to determine the manufacturer of the connected heater unit.

The main body may further comprise an interface configured to be connected to an external power source. The external power source may recharge the power supply of the main body. The main body may further comprise an interface configured to be connected to an external data source.

The main body may be configured to communicate with an external device, such as a smartphone. For example, the main body may comprise an radio-frequency (RF) system configured to communicate wirelessly with a smartphone. The main body may be configured to exchange data with an external device.

The main body may comprise a first identification element. The heater unit may comprise a second identification element.

One or both of the first identification element and the second identification element may be configured such that the main body identifies the heater unit connected to the main body. One or both of the first identification element and the second identification element may be configured such that the main body identifies the individual heater unit connected to the main body. One or both of the first identification element and the second identification element may be configured such that the main body identifies the type of heater unit connected to the main body. One or both of the first identification element and the second identification element may be configured such that the main body identifies the generation or version of a specific type of heater unit connected to the main body.

One or both of the first identification element and the second identification element may allow to distinguish between heater units of different manufacturers. One or both of the first identification element and the second identification element may distinguish a heater unit of an authorized manufacturer from a heater of an unauthorized manufacturer. One or both of the first identification element and the second identification element may be used to identify counterfeit heater units.

The second identification element may comprise first heater unit identification information.

The main body may be configured to identify the heater unit connected to the main body according to the heater unit identification information. The main body may be configured to process the heater unit identification information. The heater unit identification information may be one or more of a mechanical signal, an electrical signal, an analogue signal and a digital signal. The heater unit identification information may be encrypted.

The first identification element of the main body may be configured to read the first heater unit identification information of the second identification element thereby identifying the first heater unit.

The main body further may comprise a controller configured to control the supply of electrical energy from the power supply to the heating element. The controller may be configured to control the supply of electrical energy based on the identified first heater unit.

The controller may be configured to control the supply of electrical energy from the power supply to the heating element in dependence on the specific heater unit or specific type of heater unit connected to the main body. The specific heater unit connected may be identified using the heater unit identification information. The specific type of heater unit connected may be identified using the heater unit identification information.

The controller may be configured to control the supply of a current and voltage delivered by the power supply to the heating element in dependence on the specific heater unit connected to the main body. The controller may be configured to select a specific heating profile in dependence of the specific heater unit connected to the main body. The controller may be configured to select a specific electrical signal profile in dependence of the specific heater unit connected to the main body.

The controller may be configured to provide to a connected heater unit, in dependence on the heater unit identification information, an electrical current and voltage that is compatible with heater unit. The controller may be configured to provide to a connected heater unit, in dependence on the heater unit identification information, a heating profile that is compatible with heater unit. The controller may be configured to provide to a connected heater unit, in dependence on the heater unit identification information, an electrical signal profile that is compatible with heater unit.

Some types of heater units may be supplied with a direct current. Some types of heater units may be supplied with an alternating current. The controller may be configured to provide to a connected heater unit, in dependence on the heater unit connected to the main body, a direct current or an alternating current. The controller may be configured to provide to the connected heater unit, in dependence on the heater unit connected to the main body, a direct or an alternating current voltage.

Identification of the connected heater unit and subsequent control of the supply of electrical energy from the power supply to the heating element may be automated. In this way, the comfort of usage for the user may be improved.

The controller may comprise a memory element. The memory element may comprise a database. The database may comprise a variety of heating profiles. The database may comprise a variety of electrical signal profiles. The database may comprise a variety of heater unit identification information. The controller may read the memory element. The controller may be configured to process data from the database of the memory element. The controller may be configured to process the heater unit identification information.

The controller may be configured to allocate a specific heating profile or specific electrical signal profile to specific heater unit identification information. The controller may be configured to select a suitable heating profile or electrical signal profile according to the allocation of the heating profile or electrical signal profile to the heater unit identification information. By comparing the heater unit identification information obtained by one or both of the first identification element and the second identification element with the heater unit identification information stored in the memory element, and by allocating to the heater unit identification information a specific heating profile or electrical signal profile, the controller may select a heating profile or electrical signal profile suitable to the heater unit connected to the main body. The controller may be configured control delivery of such heating profile (or corresponding electrical energy profile) or electrical signal profile from the power supply to the heating element of the heater unit.

By identifying the connected heater unit and providing a response, such as a specific heating profile or electrical signal profile, tailored to the connected heater unit, the consumption of experience for the user may be optimized.

The control of the type of current or voltage (alternating vs. direct) delivered may be achieved by using an electronic circuit.

In one embodiment, control of the type of current or voltage (alternating vs. direct) may be achieved by using an inverter having an H-bridge arrangement.

The H-bridge arrangement may comprise four switches with a load at the center, in an H-like configuration. H-bridge switches may be transistors, the bases of which being linked to electronic oscillators (usually RC or RLC circuits). Only when the transistors' base receives a (small) current, the transistors may let the current flow from its collector to its emitter (switch is closed) otherwise the switch may be open. An oscillators' component values may define the frequency of the generated alternating current.

The H-bridge arrangement may create square waves. Known rectification arrangements may allow to achieve from it modified sine waves or sine waves.

The H-bridge may utilise NPN transistors as the switches. When the oscillator provides a very small current to the base of the NPN transistor, the current may flow from the collector of the NPN transistor to the emitter of the NPN transistor.

The control of the type of current or voltage (alternating vs. direct) may be achieved by using a H-bridge arrangement, with the bases of the transistors being furthermore controlled by MOSFET.

Furthermore, a converter may be be used to increase and decrease the current and voltage output.

Other ways of controlling the type of current and voltage (alternating vs. direct) are possible and the invention is not limited to the example of H-bridge arrangements discussed above.

The controller may be configured to control the interface. The controller may be configured to control the display of information relating to the specific heater unit attached to the main body on the interface. The controller may be configured to process the input of the user obtained through the interface.

The main body may comprise a first electrical contact. The first heater unit may comprise a second electrical contact. The first electrical contact and the second electrical contact may be configured to establish an electrical connection between the main body and the first heater unit when the first connection element of the main body is connected with the second connection element of the first heater unit.

One or more of the first electrical contact and the second electrical contact may be configured to transfer data. One or more of the first electrical contact and the second electrical contact may be configured to transfer heater unit identification information. One or more of the first electrical contact and the second electrical contact may be configured to transfer heater unit identification information between the first identification element of the main body and the second identification element of the heater unit connected to the main body. One or more of the first electrical contact and the second electrical contact may be configured to transfer electrical energy. One or more of the first electrical contact and the second electrical contact may be configured to transfer electrical energy from the power supply to the heating element. One or more of the first electrical contact and the second electrical contact may be configured to transfer a current. One or more of the first electrical contact and the second electrical contact may be configured to transfer electrical power. One or more of the first electrical contact and the second electrical contact may be configured to form an interface between the main body and the heater unit. The first electrical contact and the second electrical contact may be configured to be complementary to each other.

The controller may be configured to regulate transfer of data via one or more of the first electrical contact and the second electrical contact. The controller may be configured to regulate transfer of electrical energy via one or more of the first electrical contact and the second electrical contact.

One or both of the first identification element and the second identification element may comprise one or more of a mechanical identification element, and electrical identification element, a wireless identification element, an NFC reader, an NFC tag, an NVM such as an OTP, EPROM or EEPROM and an encrypted identification element.

One or both of the first identification element and the second identification element may allow the main body to identify the heater unit.

In an embodiment of a mechanical identification element, the second identification element may comprise at least one pushing element, such as a pin. The first identification element may comprise at least one movable element. The movable element may be complementary to the pushing element. The pushing element may be configured such that a specific mechanical configuration of the movable element allowing the identification of the heater unit is adopted when the main body is connected to heater unit. Alternatively, the first identification element may comprise the at least one pushing element, and the second identification element may comprise the at least one movable element

In an embodiment of an electrical identification element, one or more of the heater unit and the main body may be configured to establish or break at least one current line between the main body and the heater unit when the main body and the heater are connected. The positions and number of the open/closed current lines may allow the main body, by checking which lines are closed and which are open, to identify the heater unit.

The aerosol-generating device may be configured to detect that a fresh aerosol-generating article or aerosol-forming substrate has been inserted into the heater unit connected to the main body. For example, removing an aerosol-generating article or an aerosol-forming substrate may open a current line going to the main body, while the insertion of a fresh consumable may close a current line going to the main body. By checking this current line, the main body may detected if a consumable has been inserted to or removed from the connected heater unit.

In an embodiment of a wireless identification element, the main body may comprise a near field communication (NFC) reader. The heater unit may comprise an NFC tag. The NFC reader of the main body may read the NFC tag of the heater unit. The NFC reader of the main body may be configured to send a radio frequency (RF) signal to the NFC tag of the heater unit when the main body and the heater unit are connected. The NFC tag of the heater unit may be configured to scatter back the radio frequency (RF) signal to the NFC reader of the main body, even if the NFC tag is not electrically powered. The NFC tag may add heater unit identification information to the scattered RF signal. The NFC reader of the main body may be configured to identify the heater unit based on such added information.

In an embodiment of an identification element, the heater unit may comprise a none-volatile memory (NVM). The main body may be configured to read the NVM of the heater unit via the connecting electrical lines that connect the main body to the heater unit. The NVM may contain the heater unit identification information. For example, the NVM may be selected from group consisting of a one time programmable memory (OTP), erasable programmable read-only memory (EPROM), or electrically erasable programmable read-only memory (EEPROM) or the like.

In an embodiment of an encryption identification element, the heater unit may include in a NVM the following data:
an encrypted ID (EID),
a generic ID (GID) referring to the type of heater unit, and
a unique identification value, for instance a Manufacturing Information Block (MIB).

The EID may be created by using a symmetric-key algorithm, for instance AES 128, to encrypt an Initial ID (IID), using a Major Key.

The Major Key may be created by using a shared secret common to all heater units of the same type (i.e. having the same GID) and the MIB, processed into a KDF (Key Derivative Function), like HKDF.

The device, when reading the EID, GID and MIB from the heater unit NVM, may retrieve first the shared secret associated to the GID. To do so, either all shared secrets may be recorded inside all main bodies, or the main body may be able to securely connect (by a known process) to the manufacturer server to retrieve the shared secret by providing the GID (it needs to be done only once for each GID). Then, using the KDF, the shared secret and the MIB, the device may create the Major Key, and then may use the symmetric-key algorithm to decrypt EID, and to get the IID.

The IID may include (part of) the GID and/or MIB, to confirm a correct decryption, as well as, for instance additional data to help optimize the use of the heater unit. Such data, if they relate, for instance, to different possible heating profiles, may be be displayed via the main body interface for the user to select.

In case the decrypt process is not valid, then the main body may stop working and display the problem details via its interface.

This encryption method ensures that the IID can be kept quite secure, and makes the system difficult to counterfeit.

Furthermore, in case a counterfeiter reproduces the EID, GID and MIB of one heater unit, and creates several counterfeit heater units having these same values, the counterfeit items are limited to the GID/IID type of heater unit (i.e., a kind of current/voltage/heating profile) and cannot be used for all kind of heater units.

In addition, the product manufacturer, by tracking the MIB and their geo location (for instance, this can be done via the main body connecting to the manufacturer server to provide information about the MIB/GID it was connected with), may find several instances of the same MIB, which is not possible, and communicate to all the main bodies to stop processing such MIB, making at once all the counterfeit items useless while having only to replace the only one original product that has been counterfeit.

The above discussed identification systems may also be combined.

The first connection element of the main body and the second connection element of the first heater unit may be configured as mechanical connection elements.

One or more of the first connection element and the second connection element may be magnetic coupling elements. One or more of the first connection element and the second connection element may be bayonet coupling elements. The first connection element may be a lip or pin and the second connection element may be a complementary dent or vice versa. One or more of the first connection element and the second connection element may be friction coupling elements. The first connection element may be screwing element and the second connection element may be a complementary threaded element or vice versa. One or more of the first connection element and the second connection element may be electrical coupling elements

The aerosol-forming substrate of the first heater unit may comprise a solid aerosol-forming substrate or a liquid aerosol-forming substrate.

The heating element may comprise a resistance heater or an induction heater.

The heating element may be arranged at least partly surrounding the receiving region or may be arranged at least partly penetrating into the receiving region.

The first heater unit may comprise an air inlet and an air outlet which may be fluidly connected.

The air inlet and the air outlet may be fluidly connected via an airflow channel.

The main body may comprise at least one air inlet and the heater unit may comprise at least one air outlet. The air inlet of the main body may be fluidly connected to the air outlet of the heater unit when the heater unit is connected to the main body. The air inlet of the main body may be fluidly connected to the air outlet of the heater unit via the airflow channel. The airflow channel may at least partially extend through a part of the main body.

The power supply may comprise a rechargeable battery.

The first heater unit may comprise a mouthpiece.

In a second aspect, the invention further relates to a kit comprising an aerosol-generating device as described herein and a second heater unit comprising a second connection element, a heating element and a receiving region configured to receive an aerosol-forming substrate. The first connection element of the main body is configured to be removably connectable with the second connection element of the second heater unit such that the second heater unit is securely held adjacent the main body and such that electrical energy can be supplied from the power supply to the heating element. The receiving region of the first heater unit is configured to receive a different aerosol-forming substrate than the receiving region of the second heater unit.

The first heater unit of the kit may be configured to receive solid aerosol-forming substrate. The second heater unit of the kit may be configured to receive liquid aerosol-forming substrate.

The features described herein with regard to the first heater unit may equally be features of the second heater unit.

As used herein, the terms ‘proximal’, ‘distal’, ‘downstream’ and ‘upstream’ are used to describe the relative positions of components, or portions of components, of the aerosol-generating device in relation to the direction in which a user draws on the aerosol-generating device during use thereof.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention may be arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The heating element may be configured as a resistance heating element (resistance heater). The heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum platinum, gold and silver. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese-, gold-and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required. The heating element may exemplarily be a coil heater, a capillary tube heater, a mesh heater or a metal plate heater.

One or both of the first heater unit and the second heater unit may comprise an internal heating element or an external heating element, or both internal and external heating elements, where “internal” and “external” refer to the aerosol-forming substrate. An internal heating element may take any suitable form. For example, an internal heating element may take the form of a heating blade. Alternatively, the internal heater may take the form of a casing or substrate having different electro-conductive portions, or an electrically resistive metallic tube. Alternatively, the internal heating element may be one or more heating needles or rods that run through the center of the aerosol-forming substrate. Other alternatives include a heating wire or filament, for example a Ni—Cr (Nickel-Chromium), platinum, tungsten or alloy wire or a heating plate. Optionally, the internal heating element may be deposited in or on a rigid carrier material. In one such embodiment, the electrically resistive heating element may be formed using a metal having a defined relationship between temperature and resistivity. In such an exemplary device, the metal may be formed as a track on a suitable insulating material, such as ceramic material, and then sandwiched in another insulating material, such as a glass. Heaters formed in this manner may be used to both heat and monitor the temperature of the heating elements during operation.

An external heating element may take any suitable form. For example, an external heating element may take the form of one or more flexible heating foils on a dielectric substrate, such as polyimide. The flexible heating foils can be shaped to conform to the perimeter of a substrate receiving cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. An external heating element may also be formed using a metal having a defined relationship between temperature and resistivity. In such an exemplary device, the metal may be formed as a track between two layers of suitable insulating materials. An external heating element formed in this manner may be used to both heat and monitor the temperature of the external heating element during operation.

As an alternative to an electrically resistive heating element, the heating element may be configured as an induction heating element (induction heater). The induction heating element may comprise an induction coil and a susceptor. In general, a susceptor is a material that is capable of generating heat, when penetrated by an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

The heating element may be part of one or both of the first heater unit and the second heater unit. The heating element of the first heater unit may be different to the heating element of the second heater unit. For example, the first heater unit may comprise a resistance heater, preferably a mesh heater and the second heater unit may comprise an induction heater, preferably comprising an induction coil and a susceptor.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

If the aerosol-forming substrate is a solid aerosol-forming substrate, the solid aerosol-forming substrate may comprise, in some embodiments, one or more of: powder, granules, pellets, shreds, spaghettis, strips or sheets containing one or more of: herb leaf, tobacco leaf, fragments of tobacco ribs, reconstituted tobacco, homogenised tobacco, extruded tobacco, cast leaf tobacco and expanded tobacco. The solid aerosol-forming substrate may be in loose form, or may be provided in a suitable container or cartridge. Optionally, the solid aerosol-forming substrate may contain additional tobacco or non-tobacco volatile flavour compounds, to be released upon heating of the substrate. The solid aerosol-forming substrate may also contain capsules that, for example, include the additional tobacco or non-tobacco volatile flavour compounds and such capsules may melt during heating of the solid aerosol-forming substrate.

As used herein, homogenised tobacco refers to material formed by agglomerating particulate tobacco. Homogenised tobacco may be in the form of a sheet. Homogenised tobacco material may have an aerosol-former content of greater than 5% on a dry weight basis. Homogenised tobacco material may alternatively have an aerosol former content of between 5% and 30% by weight on a dry weight basis. Sheets of homogenised tobacco material may be formed by agglomerating particulate tobacco obtained by grinding or otherwise combining one or both of tobacco leaf lamina and tobacco leaf stems. Alternatively, or in addition, sheets of homogenised tobacco material may comprise one or more of tobacco dust, tobacco fines and other particulate tobacco by-products formed during, for example, the treating, handling and shipping of tobacco. Sheets of homogenised tobacco material may comprise one or more intrinsic binders, that is tobacco endogenous binders, one or more extrinsic binders, that is tobacco exogenous binders, or a combination thereof to help agglomerate the particulate tobacco; alternatively, or in addition, sheets of homogenised tobacco material may comprise other additives including, but not limited to, tobacco and non-tobacco fibres, aerosol-formers, humectants, plasticisers, flavourants, fillers, aqueous and non-aqueous solvents and combinations thereof.

Optionally, the solid aerosol-forming substrate may be provided on or embedded in a thermally stable carrier. The carrier may take the form of powder, granules, pellets, shreds, spaghettis, strips or sheets. Alternatively, the carrier may be a tubular carrier having a thin layer of the solid substrate deposited on its inner surface, or on its outer surface, or on both its inner and outer surfaces. Such a tubular carrier may be formed of, for example, a paper, or paper like material, a non-woven carbon fibre mat, a low mass open mesh metallic screen, or a perforated metallic foil or any other thermally stable polymer matrix.

In a particularly preferred embodiment, the aerosol-forming substrate comprises a gathered crimpled sheet of homogenised tobacco material. As used herein, the term ‘crimped sheet’ denotes a sheet having a plurality of substantially parallel ridges or corrugations. Preferably, when the aerosol-generating article has been assembled, the substantially parallel ridges or corrugations extend along or parallel to the longitudinal axis of the aerosol-generating article. This advantageously facilitates gathering of the crimped sheet of homogenised tobacco material to form the aerosol-forming substrate. However, it will be appreciated that crimped sheets of homogenised tobacco material for inclusion in the aerosol-generating article may alternatively or in addition have a plurality of substantially parallel ridges or corrugations that are disposed at an acute or obtuse angle to the longitudinal axis of the aerosol-generating article when the aerosol-generating article has been assembled. In certain embodiments, the aerosol-forming substrate may comprise a gathered sheet of homogenised tobacco material that is substantially evenly textured over substantially its entire surface. For example, the aerosol-forming substrate may comprise a gathered crimped sheet of homogenised tobacco material comprising a plurality of substantially parallel ridges or corrugations that are substantially evenly spaced-apart across the width of the sheet.

The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

The aerosol-forming substrate may be a substrate capable of releasing volatile compounds that can form an aerosol. The volatile compounds may be released by heating the aerosol-forming substrate. The aerosol-forming substrate may comprise plant-based material. The aerosol-forming substrate may comprise tobacco. The aerosol-forming substrate may comprise a tobacco-containing material containing volatile tobacco flavour compounds, which are released from the aerosol-forming substrate upon heating. The aerosol-forming substrate may alternatively comprise a non-tobacco-containing material. The aerosol-forming substrate may comprise homogenised plant-based material.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The aerosol-forming substrate may also be provided in a liquid form. The liquid aerosol-forming substrate may comprise other additives and ingredients, such as flavourants. The liquid aerosol-forming substrate may comprise water, solvents, ethanol, plant extracts and natural or artificial flavours. The liquid aerosol-forming substrate may comprise nicotine. The liquid aerosol-forming substrate may have a nicotine concentration of between about 0.5% and about 10%, for example about 2%. The liquid aerosol-forming substrate may comprise an aerosol-former. The liquid aerosol-forming substrate may be contained in a liquid storage portion of the aerosol-generating article, in which case the aerosol-generating article may be denoted as a cartridge.

Liquid aerosol-forming substrate may be provided in a liquid storage portion. The liquid storage portion may be adapted for storing the liquid aerosol-forming substrate to be supplied to the heating element. The liquid storage portion may be configured as a container or a reservoir for storing the liquid aerosol-forming substrate.

Preferably, the liquid storage portion is capable of being coupled to at least one pumping device and the heating element by a respective coupling hermetically sealed against surrounding atmosphere. Preferably, the couplings are configured as self-healing pierceable membranes. The membranes avoid undesired leaking of the liquid aerosol-forming substrate stored in the liquid storage portion. The liquid storage portion may be configured as a replaceable tank or container. For coupling the replaceable liquid storage portion to the pumping device and/or the heating element a respective needle-like hollow tube may be pierced through a respective membrane. When the pumping device and/or the heating element are coupled to the liquid storage portion, the membranes avoid undesired leaking of the liquid aerosol-forming substrate and leaking of air from and into the liquid storage portion.

The liquid storage portion may be any suitable shape and size. For example, the liquid storage portion may be substantially cylindrical. The cross-section of the liquid storage portion may, for example, be substantially circular, elliptical, square or rectangular.

The liquid storage portion may comprise a housing. The housing may comprise a base and one or more sidewalls extending from the base. The base and the one or more sidewalls may be integrally formed. The base and one or more sidewalls may be distinct elements that are attached or secured to each other. The housing may be a rigid housing. As used herein, the term ‘rigid housing’ is used to mean a housing that is self-supporting. The rigid housing of the liquid storage portion may provide mechanical support to the aerosol-generating article. The liquid storage portion may comprise one or more flexible walls. The flexible walls may be configured to adapt to the volume of the liquid aerosol-forming substrate stored in the liquid storage portion. The housing of the liquid storage portion may comprise any suitable material. The liquid storage portion may comprise substantially fluid impermeable material. The housing of the liquid storage portion may comprise a transparent or a translucent portion, such that liquid aerosol-forming substrate stored in the liquid storage portion may be visible to a user through the housing. The liquid storage portion may be configured such that aerosol-forming substrate stored in the liquid storage portion is protected from ambient air. The liquid storage portion may be configured such that aerosol-forming substrate stored in the liquid storage portion is protected from light. This may reduce the risk of degradation of the substrate and may maintain a high level of hygiene.

The liquid storage portion may be substantially sealed. The liquid storage portion may comprise one or more outlets for liquid aerosol-forming substrate stored in the liquid storage portion to flow from the liquid storage portion to the heating element. The liquid storage portion may comprise one or more semi-open inlets. This may enable ambient air to enter the liquid storage portion. The one or more semi-open inlets may be semi-permeable membranes or one-way valves, permeable to allow ambient air into the liquid storage portion and impermeable to substantially prevent air and liquid inside the liquid storage portion from leaving the liquid storage portion. The one or more semi-open inlets may enable air to pass into the liquid storage portion under specific conditions. The liquid storage portion may be arranged permanently in the main body of the aerosol-generating device. The liquid storage portion may be refillable. Alternatively, the liquid storage portion may be configured as a replaceable liquid storage portion. The liquid storage portion may be part of or configured as a replaceable cartridge. The aerosol-generating device may be configured for receiving the cartridge. A new cartridge may be attached to the aerosol-generating device when the initial cartridge is spent.

Preferably, the first heater unit is configured to receive a solid aerosol-forming substrate and the second heater unit is configured to receive a liquid aerosol-forming substrate. The solid aerosol-forming substrate may be a tobacco rod. The solid aerosol-forming substrate may be part of a rod-shaped aerosol-generating article. Such aerosol-generating article may be configured to be inserted into the first heater unit. A liquid storage portion may be configured to hold the liquid aerosol-forming substrate. The liquid storage portion may be part of a cartridge. The cartridge may be configured to be insertable into the second heater unit.

The receiving region may comprise a cavity. The cavity may have an open end into which one or more of the aerosol-forming substrate and the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device. The cavity may comprise one or more walls. The walls of the cavity may enclose the cavity. The walls of the cavity may extend from the base of the cavity. The walls of the cavity may extend from the base of the cavity towards the open end of the cavity. The walls of the cavity may correspond to the walls of the housing of the heater unit.

The cavity may be configured as a heating chamber. The cavity may have a cylindrical shape. The cavity may have a hollow cylindrical shape. The cavity may have a shape corresponding to the shape of the aerosol-generating article or aerosol-forming substrate to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, the mouthpiece may be arranged or a user may directly draw on the aerosol-generating article. The airflow channel may extend through the mouthpiece. The mouthpiece may comprise the air outlet.

The receiving region may be configured to receive the liquid storage portion. The cavity may be configured to receive the liquid storage portion. The heating element may be arranged at least partly surrounding the cavity or may be arranged at least partly penetrating into the cavity. The heating element may be arranged in the walls of the cavity

One or more of the first heater unit and the second heater unit may be provided with at least one air inlet. The air inlet may be a semi-open inlet. The semi-open inlet may be an inlet which permits air or fluid flow in one direction, such as into the device, but at least restricts, preferably prohibits, air or fluid flow in the opposite direction. The semi-open inlet preferably allows air to enter the aerosol-generating device. Air or liquid may be prevented from leaving the aerosol-generating device through the semi-open inlet. The semi-open inlet may for example be a semi-permeable membrane, permeable in one direction only for air, but is air-and liquid-tight in the opposite direction. The semi-open inlet may for example also be a one-way valve. Preferably, the semi-open inlets allow air to pass through the inlet only if specific conditions are met, for example a minimum depression in the aerosol-generating device or a volume of air passing through the valve or membrane.

The power supply of the main body may be a Lithium-ion battery. Alternatively, the power supply of the main body may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply of the main body may be another form of charge storage device such as a capacitor. The power supply of the main body may require recharging and may have a capacity that enables to store enough energy for one or more usage experiences; for example, the power supply of the main body may have sufficient capacity to continuously generate aerosol for a period of around six minutes or for a period of a multiple of six minutes. In another example, the power supply of the main body may have sufficient capacity to provide a predetermined number of puffs or discrete activations of the heating element.

The aerosol-generating device may comprise electric circuitry. The electric circuitry may comprise the controller The electric circuitry may comprise a microprocessor, which may be a programmable microprocessor. The microprocessor may be part of the controller. The electric circuitry may comprise further electronic components. The electric circuitry may be configured to regulate a supply of power to the heating element. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The electric circuitry may comprise a storage of one or more of heating profiles and electrical signal profiles. The electric circuitry may be configured to allocate heater unit identification information to one or more of a specific heating profile and electrical signal profile. The electric circuitry may be configured to regulate a supply of power to the heating element according to the specific electrical signal profile allocated to the heater unit identification information. The electric circuitry may be configured to regulate the temperature of the heating element according to the specific heating profile allocated to the heater unit identification information.

Different embodiments of the heater unit may utilize different types of aerosol-generating articles or aerosol-forming substrates (for example, a solid aerosol-forming substrate or a liquid aerosol-forming substrate) or different types of heating elements.

For instance, one embodiment of the heater unit comprises a resistance heater in the wall of the cavity configured to receive a rod-shaped aerosol-generating article. In this embodiment, the heater unit may generate resistance heating on receiving direct current from the main body at an appropriate voltage.

In another embodiment, the cavity of the heater unit comprises at least part of a resistance heating blade. The heating blade may be inserted into a rod-shaped aerosol-generating article.

Another embodiment of the heater unit comprises a flat induction coil and a flat susceptor. The flat susceptor may be arranged on the flat coil. The heater unit may comprise a flat aerosol-generating article or flat aerosol-forming substrate. The article or the substrate may be arranged on the susceptor. In such case, the heater unit may generate, on receiving alternating current from the main body, and via its flat induction coil, an alternating magnetic field that may create Eddy currents in the flat susceptor. These Eddy currents may heat by Joules law—resistance heating—the flat susceptor on which the flat article or substrate may be arranged.

Another embodiment of the heater unit may comprise a cavity. An induction coil may at least partially surround the cavity. The induction coil may be arranged in the walls of the cavity. An aerosol-generating article or an aerosol-forming substrate may be inserted into the cavity. The article or the substrate may comprise a susceptor. In this embodiment, the heater unit may generate, via the induction coil, an alternating magnetic field on receiving alternating current from the main body.

Another embodiment of the heater unit may comprise a cavity configured to receive a liquid aerosol-forming substrate.

Another embodiment of the heater unit may comprise a closed cavity. The closed cavity may be configured to hold liquid aerosol-forming substrate. The cavity may be configured such that liquid aerosol-forming substrate may be inserted into the cavity. The heating element may be a resistance heating wire.

Another embodiment of the heater unit may comprise a cavity. An induction coil may at least partially surround the cavity. The induction coil may be arranged in the walls of the cavity. A flat induction coil may be arranged at the base of the cavity. The cavity may comprise at the base of the cavity granules comprising a susceptor core and an aerosol-forming substrate coating.

Below, there is provided a non-exhaustive list of non-limiting examples. Any one or more of the features of these examples may be combined with any one or more features of another example, embodiment, or aspect described herein.

Features described in relation to one embodiment may equally be applied to other embodiments of the invention.

The invention will be further described, by way of example only, with reference to the accompanying drawings in which:

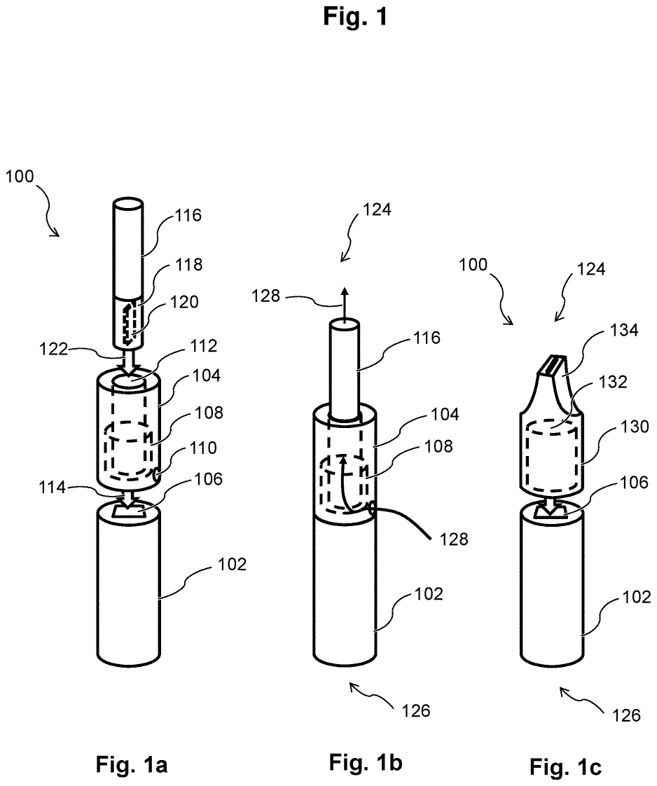

FIG. 1 shows embodiments of an inventive aerosol-generating device. FIG. 1a shows an exploded view of a first embodiment of the aerosol-generating device comprising a rod-shaped aerosol-generating article, FIG. 1b shows a (non-exploded) view of the same device, and FIG. 1c shows a second embodiment of the aerosol-generating device, which comprises a heater unit comprising liquid aerosol-generating substrate. ;

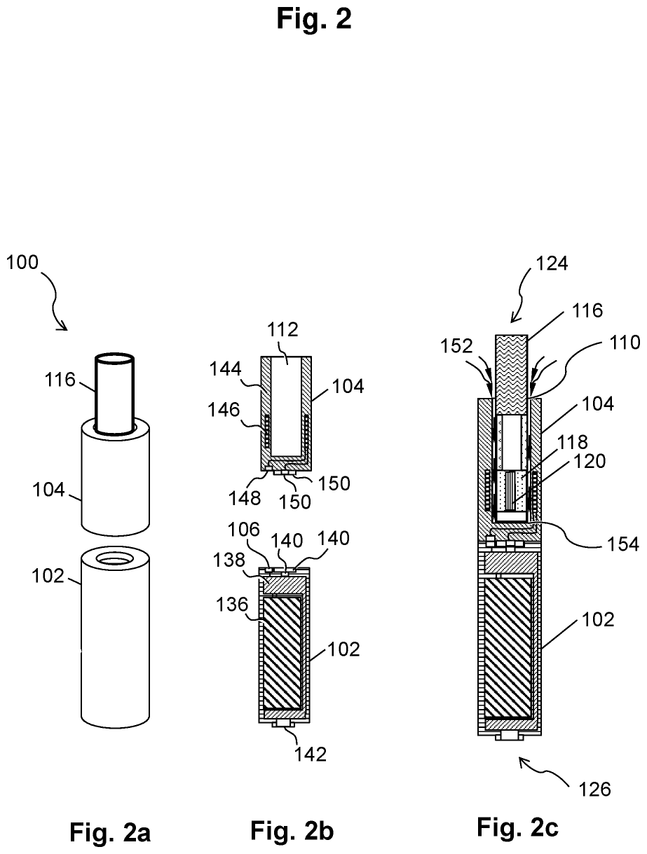

FIG. 2 shows a third embodiment of the inventive aerosol-generating device comprising an induction heater. FIG. 2a shows an outside view of the device, FIG. 2b and FIG. 2c show a cross-section of the device;

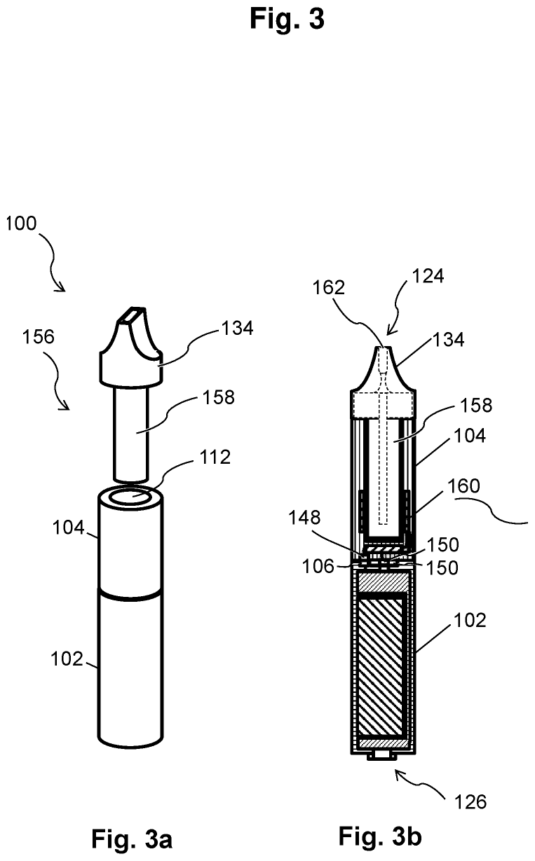

FIG. 3 shows a fourth embodiment of the inventive aerosol-generating device comprising liquid aerosol-forming substrate. FIG. 3a shows an outside view of the device and FIG. 3b shows a cross-section of the device; and

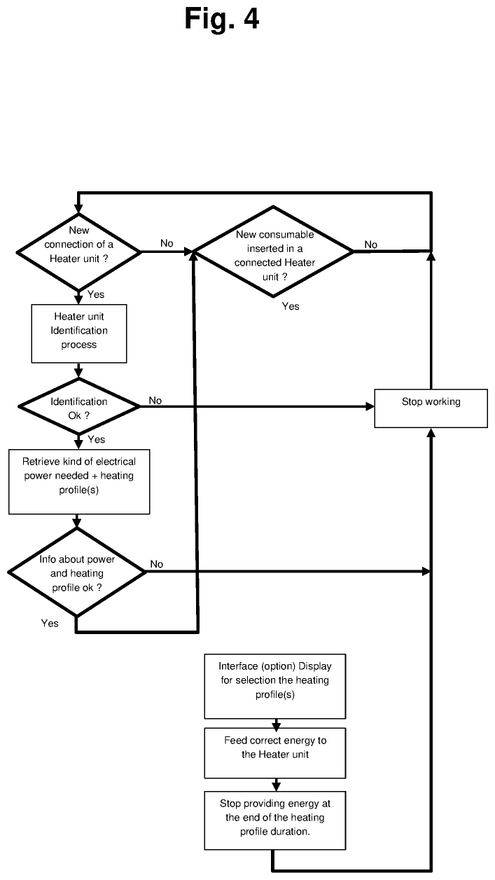

FIG. 4 shows a simplified working algorithm of the main body.

FIG. 1 shows two embodiments of an aerosol-generating device (100). FIG. 1a shows an exploded view of the aerosol-generating device comprising a main body (102) and a first heater unit (104). The main body comprises a first connection element (106), a battery (not shown), an interface (not shown), a controller (not shown) and a first identification element (not shown). The heater unit comprises a second connection element (not shown), a second identification element (not shown), a heating element (108) comprising an induction heater (comprising an induction coil), an air inlet (110) and a receiving section comprising a cavity (112). As indicated by arrow 114, the heater unit can be connected to the main body via the first connection element and second connection element. FIG. 1a further shows a rod-shaped aerosol-generating article (116). The aerosol-generating article comprises solid aerosol-forming substrate (118). A susceptor (120) is embedded in the aerosol-forming substrate. As indicated by arrow 122 the rod-shaped aerosol-generating article may be inserted into the cavity of the heater unit.

FIG. 1b shows the assembled aerosol-generating device (100) of FIG. 1a with the aerosol-generating article (116) inserted into the cavity (112) of the heater unit. The induction coil (108) surrounds the part of the aerosol-generating article comprising the aerosol-forming substrate (118) and susceptor (120). The device comprises a proximal end (124) and a distal end (126)

In use, the user draws on the aerosol-generating article at the proximal end 124 such that air is drawn into the heater unit through the air inlet (110) as indicated by arrow 128. The main body identifies the connected heater unit by means of the first identification element (not shown) of the main body and the second identification element (not shown) of the connected heater unit (104). Upon identification of the connected heater unit, the main body adopts the electrical energy provided according to the identified heater unit connected. The battery of the main body (102) delivers electrical energy to the induction coil (108) via the connection formed between the first connection element and the second connection element. As the heater unit comprises an induction heating mechanism, the main body delivers an alternating current (rather than a direct current) to the induction coil. The induction coil creates an alternating magnetic field around the inserted aerosol-forming substrate to create an Eddy current in the susceptor embedded in the aerosol-forming substrate. The heat generated from the susceptor heats and at least partially vaporizes the aerosol-forming substrate. As further indicated by arrow 128 the drawn air into the device through the air inlet travels through the aerosol-forming substrate and picks up the vapor formed from the aerosol-forming substrate by the heating action of the susceptor, such that an aerosol is formed. The aerosol formed is sucked into to mouth of the consumer via the proximal end of the aerosol-generating article as indicated by arrow 128.

FIG. 1c shows an aerosol-generating device comprising with a second heater unit (130). The main body (102) of the device of FIG. 1c is the same main body (102) as shown in FIG. 1a and FIG. 1b. The main body (102), the first heater unit (104) and the second heater unit (130) form a kit of the invention.

The second heater unit (130) comprises a liquid storage portion (132) and an air inlet (not shown). The liquid storage portion comprises liquid aerosol-forming substrate. The liquid storage portion is configured to be refillable with the liquid aerosol-forming substrate. The second heater unit (130) further comprises a heating element comprising a resistance heater, in particular a resistive heating mesh (not shown). The resistive heating mesh is arranged to heat the liquid aerosol-forming substrate. The second heater unit (130) further comprises a mouthpiece (134) at the proximal end and a second connection element (not shown).

In use, the user draws on the mouthpiece (134) such that air is drawn into the heater unit through the air inlet (not shown). The main body identifies the connected second heater unit (130) by means of the first identification element (not shown) of the main body and the second identification element (not shown) of the connected second heater unit (130). Upon identification of the connected heater unit, the main body adopts the electrical energy provided according to the identified heater unit connected. The battery of the main body (102) delivers electrical energy to the resistive heating mesh (not shown) via the connection formed between the first connection element and the second connection element. As the connected second heater unit (130) comprises a resistance heater, the main body delivers a direct current (rather than an alternating current as discussed in relation to the induction heater of the heater unit of FIG. 1a and FIG. 1b). Upon the delivery of the electrical energy from the battery, the resistive heating mesh generates heat. The heat generated from the resistive heating mesh at least partially vaporizes the liquid aerosol-forming substrate. The air drawn into the device though the air inlet picks up the vapor formed from the liquid aerosol-forming substrate by the heating action of the resistive heating mesh, such that an aerosol is formed. The aerosol formed is sucked into to mouth of the consumer via the proximal end of the mouthpiece (134).

FIG. 2 shows a further embodiment of the aerosol-generating device. FIG. 2a shows an outside view of the device comprising the main body (102), heater unit (104) and aerosol-generating article (116).

FIG. 2b and FIG. 2c show a cross-section through the aerosol-generating device. In FIG. 2b, the main body (102) and the heater unit (104) are shown separated from each other, while in FIG. 2c, the heater unit (104) is shown connected to the main body (102).

The main body comprises a power supply (battery) (136), a controller (138), a first connection element (106) and first electrical contacts (140). One of the electrical contacts is configured to transfer electrical energy, the other of the electrical contacts is configured to transfer data. The main body further comprises an interface configured to be connected to an external power supply (142). The external power supply may be an electricity grid or a powerbank. Additionally or alternatively, a data port may be installed at the position of the connection for an external power supply.

The heater unit comprises the cavity (112), a wall (144), an induction coil (146), a second connection element (148) and second electrical contacts (150). One of the electrical contacts is configured to transfer electrical energy, the other of the electrical contacts is configured to transfer data.

FIG. 2c shows the main body (102) connected to the heater unit via the first connection element (106) and the second connection element (148). The heater unit (104) is mounted abutting the main body (102). Furthermore, an aerosol-generating article comprising aerosol-forming substrate (tobacco rod) (118) with an susceptor (120) embedded in the tobacco rod is shown to be inserted into the cavity of the heater unit.

In use, the user draws on the aerosol-generating article at the proximal end 124 such that air is drawn into the heater unit through the air inlet (110) formed between the walls (144) of the heater unit and the inserted aerosol-generating article as indicated by arrows 152. The controller (138) of the main body (102) identifies the connected heater unit by means of the first identification element (not shown) of the main body and the second identification element (not shown) of the connected heater unit (104). First heater unit identification data for identifying the heater unit is transferred from the heater unit to the main body via the second electrical contacts (150) and first electrical contacts (140).

Upon identification of the connected heater unit, the controller (138) of the main body adopts the electrical energy provided according to the identified heater unit connected. Regulated by the controller, the battery (136) of the main body (102) delivers electrical energy to the induction coil (146) via the first electrical contacts (140) and second electrical contacts (150). As the heater unit comprises an induction heating mechanism, the main body delivers an alternating current (rather than a direct current) to the induction coil. The induction coil creates an alternating magnetic field around the inserted tobacco rod (118) to create an Eddy current in the susceptor (120) embedded in the tobacco rod. The heat generated from the susceptor heats and at least partially vaporizes components of the tobacco rod. As further indicated by arrows 152 the air into drawn into the device through the air inlet (110) travels along in the space formed between the wall (144) of the heater unit and the aerosol-generating article. At the base (154) of the cavity (112), the air is drawn into the tobacco rod and picks up the vapor formed from the tobacco rod by the heating action of the susceptor, such that an aerosol is formed. The aerosol formed is sucked into to mouth of the consumer via the proximal end of the aerosol-generating article. When the aerosol-generating article is depleted, a new aerosol-generating article may be inserted into the cavity of the heater unit to provide further consumption experiences.

The battery may be recharged by an external power source by connecting such external power source to the interface (142) for an external power supply.

FIG. 3 shows a further embodiment of the aerosol-generating device. FIG. 3a shows the device comprising the main body (102) and heater unit (104). The main body is the same main body as shown in FIG. 2. A cartridge (156) comprising a mouthpiece (134) and a liquid storage portion (158) may be inserted into the heater unit.

FIG. 3b shows the device with the cartridge (156) being inserted into the cavity (112) of heater unit in a cross-sectional view. The heater unit is coupled to the main body via the first connection element (106) and the second connection element (148). The heater unit comprises a resistance heater (160). The resistance heater surrounds the distal end of the cavity (112). The liquid storage portion (158) of the cartridge comprises liquid aerosol-forming substrate.

In use, the user draws on the mouthpiece (134) at the proximal end 124 such that air is drawn into the heater unit through the air inlet (not shown). The controller (138) of the main body (102) identifies the connected heater unit by means of the first identification element (not shown) of the main body and the second identification element (not shown) of the connected heater unit (104). First heater unit identification data for identifying the heater unit is transferred from the heater unit to the main body via the second electrical contacts (150) and first electrical contacts (140).

Upon identification of the connected heater unit, the controller (138) of the main body adopts the electrical energy provided according to the identified heater unit connected. Regulated by the controller, the battery (136) of the main body (102) delivers electrical energy to the resistance heater (160) via the first electrical contacts (140) and second electrical contacts (150). As the heater unit comprises a resistance heater, the main body delivers a direct current (rather than a alternating current) to the resistance heater. The heat generated from the resistance heater heats at least the distal end of the liquid storage portion and at least partially vaporizes the liquid aerosol-forming substrate. Air drawn into the device picks up the vaporized aerosol-forming substrate, such that an aerosol is formed. The aerosol formed is sucked into to mouth of the consumer via an air outlet (162) of the mouthpiece.

FIG. 4 shows a simplified working algorithm of the main body as a flow diagram. The main body carries out such algorithm to check if a heater unit is connected, identify the heater unit, to check if one or both of an aerosol-generating article and an aerosol-forming substrate is inserted in the heater unit, to select a suitable heating profile or electrical signal profile based on the identified heater unit connected and to initiate supply of electrical energy to the heating element of the heater unit.

In particular, the left-hand column of the flow diagram of FIG. 4 relates connection of new heater unit and subsequent associated steps. When a new heater unit is connected to the main body, the main body identifies the connected heater unit. If such identification is unsuccessful, the main body stops working. In this way, the aerosol-generating device may be prevented to work with counterfeit heater units. If identification is successful, the main body retrieves information on the electrical signal profiles or heating profiles associated with the identified heater unit.

Once it is detected that an aerosol-generating article or aerosol-forming substrate is inserted into the heater unit, electrical energy according to the selected electrical signal profile or heating profile may be delivered to the heating element of the heater unit. The user may be prompted using the interface to select a specific heating profile, for example depending on the individual aerosol-generating article or aerosol-forming substrate inserted in the heater unit. When the aerosol-generating article or aerosol-forming substrate is depleted or when the user wishes to terminate the consumption experience, power supply to heating element is terminated.

1.-16. (canceled)

17. An aerosol-generating device, comprising:
a main body comprising a power supply and a first connection element; and
a first heater unit comprising a second connection element, a heating element, and a receiving region configured to receive an aerosol-forming substrate,
wherein the first connection element of the main body is configured to be removably connectable with the second connection element of the first heater unit such that the first heater unit is mounted abutting the main body and such that electrical energy can be supplied from the power supply to the heating element.

18. The aerosol-generating device according to claim 17,
wherein the main body further comprises a first identification element, and
wherein the heater unit further comprises a second identification element.

19. The aerosol-generating device according to claim 18, wherein the second identification element comprises first heater unit identification information.

20. The aerosol-generating device according to claim 19, wherein the first identification element of the main body is configured to read the first heater unit identification information of the second identification element thereby identifying the first heater unit.

21. The aerosol-generating device according to claim 20,
wherein the main body further comprises a controller configured to control the supply of electrical energy from the power supply to the heating element, and
wherein the controller is configured to control the supply of electrical energy based on the identified first heater unit.

22. The aerosol-generating device according to claim 17,
wherein the main body further comprises a first electrical contact,
wherein the first heater unit further comprises a second electrical contact, and
wherein the first electrical contact and the second electrical contact are configured to establish an electrical connection between the main body and the first heater unit when the first connection element of the main body is connected with the second connection element of the first heater unit.

23. The aerosol-generating device according to claim 18, wherein one or both of the first identification element and the second identification element comprises one or more of a mechanical identification element, and electrical identification element, a wireless identification element, an NFC reader, an NFC tag, an NVM, EPROM or EEPROM, and an encrypted identification element.

24. The aerosol-generating device according to claim 17, wherein the first connection element of the main body and the second connection element of the first heater unit are configured as mechanical connection elements.

25. The aerosol-generating device according to claim 17, wherein the aerosol-forming substrate of the first heater unit comprises a solid aerosol-forming substrate or a liquid aerosol-forming substrate.

26. The aerosol-generating device according to claim 17, wherein the heating element comprises a resistance heater or an induction heater.

27. The aerosol-generating device according to claim 17, wherein the heating element is arranged at least partly surrounding the receiving region or is arranged at least partly penetrating into the receiving region.

28. The aerosol-generating device according to claim 17, wherein the first heater unit further comprises an air inlet and an air outlet that are fluidly connected.

29. The aerosol-generating device according to claim 17, wherein the power supply comprises a rechargeable battery.

30. The aerosol-generating device according to claim 17, wherein the first heater unit further comprises a mouthpiece.

31. A kit comprising the aerosol-generating device according to claim 17 and a second heater unit comprising a second connection element, a heating element, and a receiving region configured to receive an aerosol-forming substrate, wherein the first connection element of the main body is configured to be removably connectable with the second connection element of the second heater unit such that the second heater unit is securely held adjacent the main body and such that electrical energy can be supplied from the power supply to the heating element, and wherein the receiving region of the first heater unit is configured to receive a different aerosol-forming substrate than the receiving region of the second heater unit.

32. The kit according to claim 31,
wherein the first heater unit is further configured to receive solid aerosol-forming substrate, and
wherein the second heater unit is further configured to receive liquid aerosol-forming substrate.
